(19) United States
(12) Patent Application Publication
(10) Pub. No.: US 2009/0302699 A1
(43) Pub. Date: Dec. 10, 2009

(54) METHOD FOR MOUNTING A BODY

(75) Inventors: JOACHIM DENK, Nurnberg (DE); Hans-Georg Kopken, Erlangen (DE); Dietmar Stoiber, Furth (DE); Bernd Wedel, Mohrendorf (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/477,503

(22) Filed: Jun. 3, 2009

(30) Foreign Application Priority Data
Jun. 4, 2008 (EP) EP08010194

(51) Int. Cl. H02K 7/09

(52) U.S. Cl. 310/90.5

(57) ABSTRACT

In a magnetic bearing arrangement, support coils are connected in series and can be fed with a current. By coupling a point connecting the two support coils to a voltage source, the support coils can be used as actuating elements and, by feeding the support coils with voltage pulses, the inductance of the support coils can be inferred which is an indication of the position of the body to be mounted. This provides for a position control arrangement. Using one and the same support coils, both a stably controlled load-bearing capacity can thus be produced and at the same time a position sensor can be replaced.

### CROSS-REFERENCES TO RELATED APPLICATIONS

This application claims the priority of European Patent Application, Serial No. EP08010194, filed Jun. 4, 2008, pursuant to 35 U.S.C. 119(a)-(d), the content of which is incorporated herein by reference in its entirety as if fully set forth herein.

### BACKGROUND OF THE INVENTION

The present invention relates to a method for mounting a body.

The following discussion of related art is provided to assist the reader in understanding the advantages of the invention, and is not to be construed as an admission that this related art is prior art to this invention.

The method involved here can be used both with linear motors and with rotary motors. An application with rotary motors is currently preferred, in which case the shaft of a rotor is mounted in the magnetic bearing. The magnetic bearing arrangement is then itself a part of the stator.

In particular, it should be possible to control the mounting actively. This implies that the magnetic field for the magnetic bearing is at least partially generated by two coils which produce the force for supporting the body and can therefore be called support coils. An actively controlled magnetic bearing arrangement is usually provided with a position sensor. The position sensor detects a measurement signal for the position of the body in the magnetic bearing arrangement and this measurement value is used as input variable (controlled variable) in a control loop. In a magnetic bearing arrangement, high demands are made of a position sensor: because of heavy loading, it is necessary that the position sensor is sufficiently rugged. The position sensor must take up little space. In the case of a rotor, the signal generated by the position sensor must only have a small phase delay and the noise power of the signal must be low. Usually, sensors which operate capacitively or inductively are used as position sensor. The use of a sensor for measuring the position entails the disadvantage that an assembly requirement arises because the sensor must be mounted and adjusted, signal lines must be run from the interior of the magnetic bearing to the evaluating electronics and these evaluating electronics must be wired to the control unit. Because of the space requirement of the position sensor, the installation space of the total system usually becomes greater than it would be without position sensor. The load-bearing capacity of the magnetic bearing is determined only by the installation size of the active magnetic parts. Due to the necessary position sensors as are used in the prior art, the installation size of the magnetic bearing increases without increasing its load-bearing capacity. From the point of view of control engineering, it is also disadvantageous that a single sensor measures the position at a single discrete point. For constructional reasons, this geometric measuring point is always remote from the site of action of the active magnetic parts. It is particularly in the case of flexural vibrations of the body to be mounted (which can occur particularly in the case of a rotor) that the amplitude of vibration at the effective area of the active magnetic part can considerably deviate from the amplitude of vibration measured at the sensor. In the extreme case, a difference in sign may even occur, as a result of which the control becomes unstable.

WO 93/23683 describes a magnetic bearing controller in which at least two series-connected electrical coils are used as bearing element, the pair of coils acting both as a position sensor and as an electromagnetic actuator. The magnetic field generated by the coils becomes superimposed on the premagnetization field generated by a pair of permanent magnets. On the one side, it produces field strengthening and on the other side field weakening, as a result of which the actual load-bearing capacity is produced. A high-frequency signal is fed into the coils. Between the two coils, the signal is picked up via a high-pass filter by a phase-sensitive rectifier, the output of which is then used in controlling the output signal applied to the coils. The measurement of potential at one point between the two coils, used in WO 93/23683, is not consistent with using the coils as support coils and premagnetization coils. If it is intended to produce the premagnetization also by coils instead of by permanent magnets, these premagnetization coils must be added as additional components to the two coils of the magnetic bearing controller.

It would therefore be desirable and advantageous to address prior art shortcomings and to provide a simple measuring method for the position of the body in which a compactly constructed, easy-to-assemble magnetic bearing arrangement can be used. If possible, optimum control of the position of the body should also be made possible.

### SUMMARY OF THE INVENTION

According to one aspect of the present invention, a method for supporting a body with a magnetic bearing arrangement having two support coils connected in series at a connecting point, with each support coil having a first terminal coupled to a terminal of corresponding first and second voltage sources and a second terminal connected to the connecting point, with the connecting point being coupled to a terminal of a third voltage source, includes the steps of generating a sequence of voltage pulses at the first and second voltage sources, and measuring an current flow between the terminal of the third voltage source caused by the voltage pulses.

The present invention is based on a magnetic bearing arrangement as described in commonly owned WO 2008/154962, published Dec. 24, 2008 and having the same inventive entity, the entire specification and drawings of which are expressly incorporated herein by reference. It has two support coils which are connected in series, the series circuit being able to have a voltage applied to it. This is made possible by the fact that the support coils which, of course, must have a first and a second terminal, are coupled, particularly connected, with their respective first terminal to a controllable voltage source. In this context, the voltage source is understood to be a unit applying a potential difference between two connection points. The respective second terminals of the two support coils are connected to one another by means of a connecting conductor. Furthermore, the connecting conductor of the two support coils is also coupled controllably to said voltage source in the magnetic bearing arrangement used. The coupling can be arranged, for example, in such a manner that the connecting conductor is connected to the first terminal of one of the two support coils by a series circuit with a further controllable voltage source. By this means, the potential difference between the connecting conductor and the first terminal of the support coil can be predetermined. There is no degree of freedom for the potential difference between the connecting conductor and the first terminal of the second support coil because it results from the fact that only two potential differences are freely selectable between any three connection points.

Various conventional methods can be used to arrange two potential differences to be predeterminable between three connection points. In this context, it is of no importance to the present invention which of the known methods is used. In the technical application in the power range of over 1 kW, pulse width modulation has proved to be successful for controlling potential differences. In this arrangement, only a single voltage source is used. In most devices of this type, the voltage source then generates a fixed potential difference between its two poles. Each of the three said connection points to which said support coil system is connected is then continuously switched back and forth between the two poles of the voltage source by means of a fast-switching switching element. Such a device is generally called “inverter” and the three connection points are called “inverter phases” or “phases”. In this arrangement, the potential difference between the connection points is controlled via the ratio of the time intervals with which the switching elements switch the phases through to the positive and, respectively, negative pole of the voltage source. The inverter is adequately well known in engineering and does not need to be described further at this point.

As a result of the series circuit of the two support coils and the additional connection of the connecting conductor, the voltages at the two terminals of the two support coils can be predetermined in such a manner that the currents in the two support coils can be individually controlled. In this arrangement, each of the two currents of the two support coils follows its respective nominal current value very contemporaneously. The magnetic bearing arrangement to which the invention is related is therefore equipped with current measuring devices by means of which the currents in at least two of the three connection points or phases can be measured. Such a current measuring device is normally used in inverters. In the coil arrangement to which the invention is related, the inflowing currents are always equal to the outflowing currents. The sum of the currents in the three connection points or phases is therefore always zero. It is therefore permissible to measure only two of the three currents directly to save one current measuring point and to determine the third current indirectly by calculation in real time. E.g.: i₃=−i₁−i₂. It is of no importance to the invention whether the third current has been determined directly by measurement or indirectly by calculation in real time.

Due to the current, each of the two support coils, which are normally wound onto magnetic yokes or groups of magnetic yokes, build up a magnetic field to the body to be supported as a result of which a force of attraction is produced between the body and the respective support coil. The two support coils are arranged with respect to the body in such a manner that the magnetic forces acting on the body, caused by their currents, are essentially located on a common line of influence but point oppositely to one another. The resultant force acting on the body is always located on the common line of influence, its magnitude and its direction of sign can be influenced by the weighting of the two currents in the two support coils. The present invention is thus related to a magnetic bearing arrangement in which the force acting on the body can be controlled by the fact that currents of different current intensity flow via the two support coils.

Unlike WO 93/23683 in which a voltage measurement is made at the tap between the coils, a potential, and thus a voltage relative to the other terminals, is applied at the tap between two coils in the present case. Only this results in the possibility of predetermining the two currents in the two support coils with different current intensity. In WO 93/23683, in contrast, the current is always of the same magnitude in the two coils. The potential at the connecting conductor is not accessed in a controlling manner. Instead, any controlling influence on the connecting conductor must even be strictly suppressed so that a high frequency difference signal, which is a voltage signal, which is unambiguous with respect to the position of the mounted body, can freely develop. In order to be able to obtain magnetic fields of different strength in spite of the two currents of equal magnitude, additional devices are necessary for superimposing another magnetic field. A permanent magnet is provided for this purpose. In the device to which the present invention is related, the currents in the two support coils can be predetermined in different current intensity by applying a controllable potential to the connecting conductor. This therefore dispenses with the necessity of providing a separate element for generating the premagnetization in addition to the support coils and, as a result, the magnetic bearing arrangement becomes particularly compact.

As in all devices which are based on a body being supported contactlessly by ferromagnetic attraction, fast control of the coil currents is also advantageous in this case. If, for example, the coil currents were predetermined statically in such a manner that the magnetic forces are in equilibrium with the force due to weight, even the smallest displacement of the body would lead to the body being pulled to a magnetic yoke and sticking to it instead of floating in the middle between the yokes. The reason for this is that, with a predetermined coil current, the magnetic field, and thus also the force of attraction, become magnified when the gap between body and magnetic yoke becomes smaller. The position of the body is unstable with statically predetermined coil currents. The body will impact at one of the two yokes with high acceleration. The control system then has the task of changing the coil currents so rapidly that the body is pulled by the opposite yoke before it impacts on one yoke. The closer the body has already approached the yoke, the more the current must be increased in the opposite yoke. This is a continual process and it is only this process which makes stable floating between the two yokes possible. Such magnetic bearing control systems have found their way into the prior art in many characteristic forms. The control system as such is not a subject matter of the present invention.

A suitable level control of the currents requires a measurement of the position of the body between the two yokes in every case. A device for magnetic mounting in which the forces are controlled with the aid of coil currents must therefore comprise at least one position sensor. According to the invention, the magnetic bearing arrangement previously described is now used at the same time as a position sensor. This is possible because the body mounted in the magnetic bearing arrangement influences the inductance of the support coils. The support coils are usually wound onto magnetic yokes and the air gap between the body and the magnetic yoke directly influences the inductance of this support coil. Since then a potential can be defined by a voltage source at the second terminals of the support coils, a sequence of voltage pulses (preferably with a constant frequency) can be generated with the aid of the voltage sources coupled to the first terminals, namely by impressing an alternating potential at the first terminals, the potential at the second terminals not changing in this manner at the same time (constant potential or potential alternating at a greater time scale). The voltage pulses produce currents in the support coils. If the voltage pulses are selected in such a manner that the currents do not balance, a resultant current flows through the voltage source coupled to the second terminals and when this current is measured, it is possible to infer the inductance of the support coils and thus the position of the body mounted in the magnetic bearing arrangement. To measure the resultant current, the existing current measuring points of an inverter can be used, for example.

The measurement is appropriately used for determining the position of the body between the magnetic yokes, and the position of the body mounted in the magnetic bearing arrangement can be controlled in a stable manner, as explained above, by a current flowing into the voltage source coupled to the second terminals. If the voltage source coupled to the second terminals is designed for delivering an additional voltage at a lower frequency than that of the voltage pulses or an additional direct voltage, the current distribution in the two support coils can be predetermined by this means. This latter voltage can then be controlled in such a manner that the measured current induced by the voltage pulses has a predetermined current intensity value, that is to say that the inductance has a predetermined value which corresponds to a predetermined air gap of the body with respect to the magnetic yokes onto which the support coils are wound.

Instead of controlling directly for the current, the position of the body to be mounted can be derived from the measured current or the measured currents, respectively. This position can be used as an actual value in a control system, a nominal value for the control system being able to be adjustable e.g. by a user. As is normal in a control system, the actual value is compared with the nominal value. The result of the comparison, e.g. a difference formed during this process, is used in controlling the additional voltage.

The voltage pulses should not exert any force on the mounted body on average. It is to be preferred, therefore, if they have a value of zero averaged in time. The current which is caused by the voltage pulses thus does not exert a force averaged in time in the individual support coils. The forces generated by the two support coils as part of the position determination are then preferably balanced exactly. This is made possible when a control device matches the voltage pulses at the respective first terminal of the support coils with respect to the potential at the respective second terminal of the support coils in such a manner to one another that the voltage/time areas (i.e. the integrals over the voltage) disappear between the two terminals of the support coils.

The method according to the invention can be used in magnetic linear guides as are used, for example, in the Transrapid. The magnetic bearing arrangement preferably belongs to a device in which the shaft of a rotor is mounted in it. The magnetic bearing arrangement is then a part of the stator. The invention for the first time provides the possibility of stably controlling the position of the shaft without a special position sensor.

If the two (or four) support coils are arranged on two opposite magnetic yokes, the position of the shaft of the rotor can be measured in one coordinate and corrected, that is to say controlled. To be able to carry out control also in the second coordinate, the same magnetic bearing arrangement must be provided a second time, if possible offset by approx. 90° (that is to say, for example, 80° to 100°, and preferably 87° to 93°) with respect to the first magnetic bearing arrangement, the magnetic bearing arrangements being able to be arranged in the same plane, namely preferably in the plane which is perpendicular to the rotor axis defined by the shaft.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 illustrates a first embodiment of a magnetic bearing arrangement which can be used in the invention, by means of a diagrammatic representation of the interconnection,

FIG. 2 illustrates a second embodiment of a magnetic bearing arrangement which can be used in the invention, by means of a diagrammatic representation of the interconnection,

FIG. 3 illustrates the variation of voltages over time in the absence of current pulses used according to the invention,

FIG. 4 illustrates the currents induced during this process,

FIG. 5 shows the variation of voltages in the presence of voltage pulses provided according to the invention,

FIG. 6 illustrates the currents induced by the voltages from FIG. 5 with an ideal position of the body to be mounted, and

FIG. 7 illustrates these currents in the case of a deviation from the ideal position of the body to be mounted.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

To mount a body designated by 10, a shaft of a rotor in the present case, a magnetic field is generated by means of which the shaft 10 is supported. The shaft 10 must be magnetically conductive. The magnetic field is produced by current which is sent through support coils which are wound onto magnetic yokes 12 and 12′, respectively, which are also magnetically conductive.

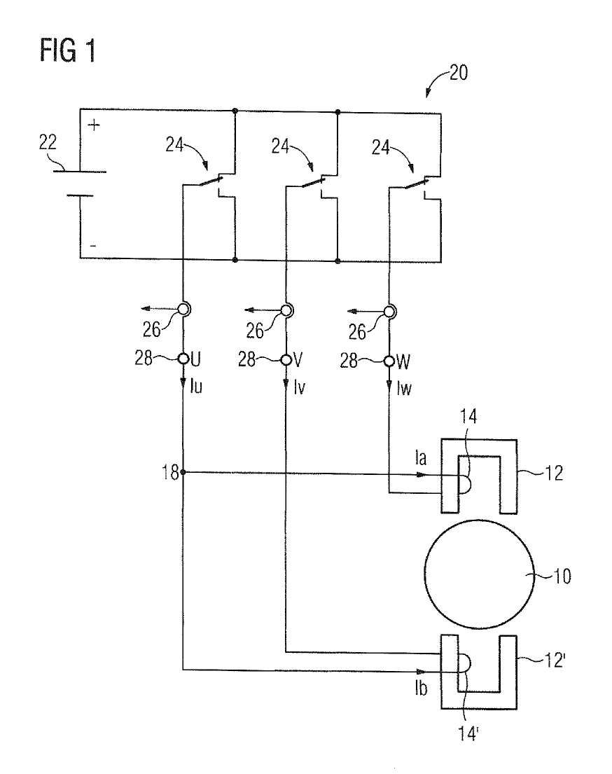

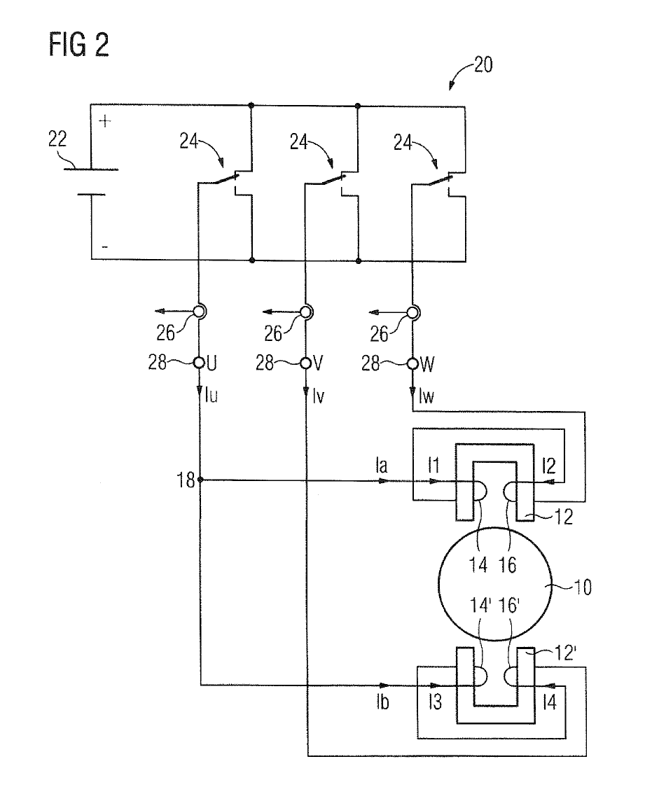

In a first embodiment of the invention according to FIG. 1, a support coil 14 and 14′ is wound onto each magnetic yoke 12 and 12′, respectively. In the embodiment according to FIG. 2, a second support coil 16 and 16′ is added to the respective first support coils 14 and 14′, respectively, on the magnetic yoke 12 and 12′, respectively. The coils 16 and 16′ can come, for example, from a magnetic bearing which is not according to the invention which is converted to a sensorless position detection system according to the invention. Such a conversion in which an existing machine is upgraded with new power electronics and new control technology but the expensive electromechanical parts remain is normal and is called “retrofit”.

Both the embodiments of the invention have in common that the support coils 14, 14′ are connected in series. Each coil 14 and 14′, respectively, has two terminals (forward and return conductor), the return conductor of coil 14 being connected to the forward conductor of coil 14′. This can be seen in such a way that second terminals of the coils 14 and 14′ are connected to a point 18. The figures show one embodiment in which a three-phase inverter 20 is used. The phases are marked by “U”, “V” and “W”. On commercially available inverters, each terminal is structured in such a way that, behind a common voltage source 22, circuit breakers 24 are arranged which regularly switch the potential of the respective connection point back and forth between the positive pole and the negative pole, that then a current measuring device 26 is provided and then the connection point 28 is provided behind the current measuring device 26.

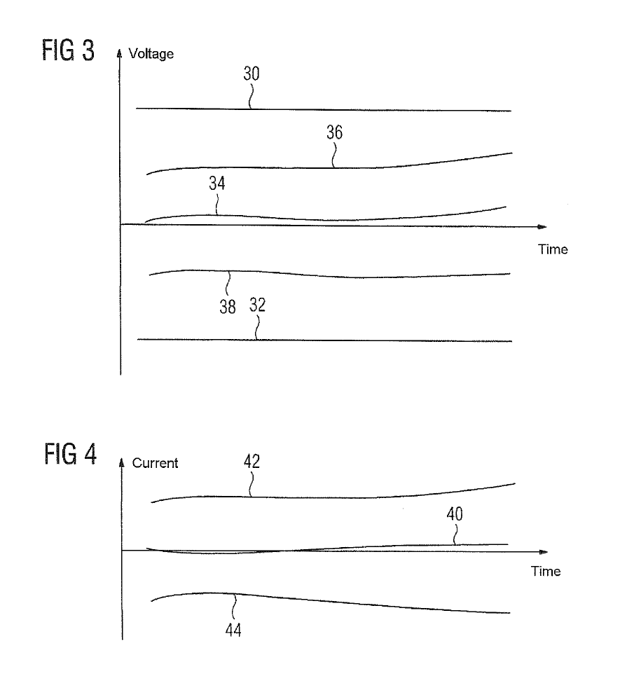

Connecting point 18 to phase U makes it possible to impress different currents on the coils 14 and 14′, namely currents Ia and Ib. This makes it possible to exert an actuating force with selectable magnitude and direction of sign on the shaft 10. The actuating force acting on the shaft 10 should then be such that the shaft 10 is controlled in a position of balance. The magnetic arrangement must therefore be capable of determining the position of the shaft 10 at least indirectly. This is done by measuring the inductance of the coils 14 and 14′, respectively, or the effects of voltage pulses on the current of phase U, respectively. FIG. 3 shows a typical voltage variation with time at the three connection points. These are the voltages which were adjusted by the control system in the time interval considered for stably supporting the body with reference to the voltage center between positive pole and negative pole of the voltage source 22. In the text which follows, they will be designated as “support voltage” to distinguish them from the voltage pulses. A curve 30 for the voltage at the positive pole of the voltage source 22, a curve 32 for the voltage at the negative pole of the voltage source 22, a curve 34 for the voltage at the connection point U, a curve 36 for the voltage at the connection point V and a curve 38 for the voltage at the connection point W are shown. In this context, the voltage at coil 14′ is the result of the difference between voltage V and voltage U and the voltage at coil 14 is the result of the difference between voltage W and voltage U. The two coil voltages can assume values which are different from one another.

The voltage variations shown in the FIG. 3 can be observed in this form at a three-phase voltage source with analog voltage generation. At a pulse-width-modulated voltage source, in contrast, the voltages toggle back and forth between the positive and the negative pole at a high switching frequency (several kHz). Strictly speaking, the voltage at a phase terminal can then not assume an intermediate state. Nevertheless, the above FIG. of the support voltage also has validity in a pulse-width-modulated system if the intermediate voltage states are interpreted as duty ratio of the pulse width modulation. Due to their inductance, the support coils smooth the current so that the same physical effect as with an analog voltage generation is produced with a sufficiently high switching frequency. It is therefore unimportant to the present invention whether the voltages at the three phases were generated as analog voltages or by PWM. For the graphic representations shown here, the analog consideration was preferred because it is more easily understood.

FIG. 4 shows a typical current variation with time at the three connection points. These are the currents which lead to the stable supporting of the body in the time interval considered. In the text which follows, they will be called “support current” in order to distinguish them from the current pulses which are produced as a reaction to the voltage pulses. Curve 40 is the current through connection point U, curve 42 is that through V, curve 44 is that through W. The current in coil 14 (phase current W) can be different from the current in coil 14′ (phase current V). However, the sum of the three phase currents must always be zero since, apart from the three connections shown, there are no further connections via which current could flow off.

Let us now consider the magnetic bearing arrangement according to the invention with added voltage pulses. In this arrangement, the voltage pulses are added to the support voltage. The voltage pulses should not excessively disturb the support current required for operation. For this reason, they should be located preferably symmetrically about the support voltage, in such a way that the proportion of the voltage/time area 46 which is located above the support voltage is balanced with the proportion which is located below the support voltage. The voltage pulses thus do not intrude into the voltage/time area of the support voltage. A suitable control device for this purpose can be integrated in the three-phase inverter 20.

The voltage pulses can be generated, for example, in a regular time sequence so that a curve shape is produced to which a constant frequency can be allocated. This frequency is preferably within the range of a few kHz. In the case of inverters having a fixed pulse frequency of the output transistors, it is very advantageous to synchronize the voltage pulses with just this fixed output pulse frequency or, respectively, to integrate them directly in the pulse pattern of the output transistors.

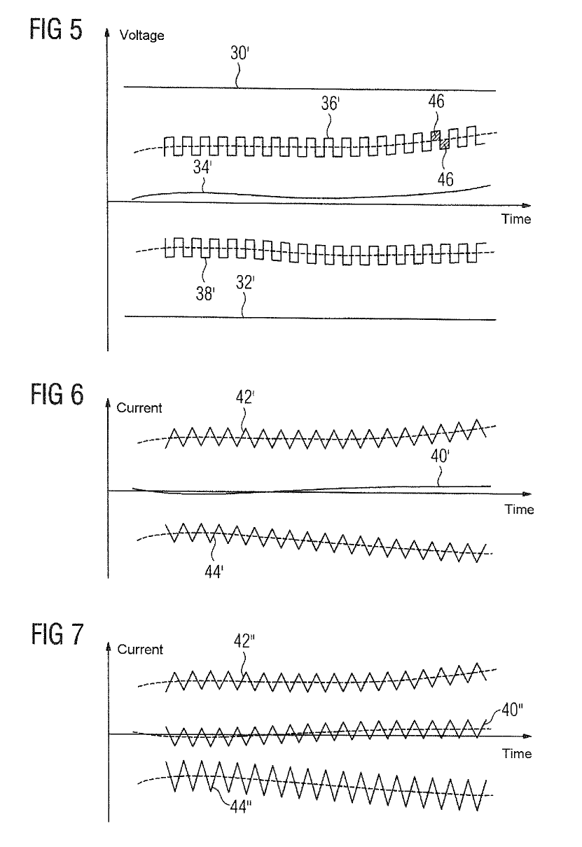

In the preferred embodiment, the voltage pulses are only switched to the first terminals of the support coils. In FIG. 1, these are terminals “V” and “W” of the drive device 20. Although there is a support voltage present at terminal “U”, voltage pulses are not connected. In the preferred embodiment, the voltage pulses at terminals “V” and “W” are connected inverted with respect to one another (it can also be said in opposite phase) so that terminal “V” can be considered to be a source and terminal “W” can be considered to be a sink for the voltage pulses. This is shown in FIG. 5 by means of curves 30′, 32′, 36′, 38′ with definition analogously to the curves from FIG. 3. The voltage pulses should also be selected in such a manner that the alternating component of the two voltage/time areas 46 is of equal magnitude at support coils 14 and 14′. Due to this symmetry, namely the oppositely phased alternating components of equal magnitude, the effect of the force caused by the voltage pulses in the two opposite magnetic yokes 12 and 12′ is largely canceled. The disturbance emanating from the voltage pulses is therefore minimal.

If an external voltage which differs from the sum of the voltages present in the circuit is applied to an inductance L, a current change di/dt is produced:

di/dt=1/L*(Uₑₓₜ−Uᵢₙₜ)
wherein Uₑₓₜ is the voltage applied externally
and Uᵢₙₜ is the voltage present in the circuit, e.g. the sum of voltage drop across resistance and induced voltage.

Without the voltage pulses being connected, the voltage applied externally is just balanced with the sum of the voltages present in the circuit so that the current of the support coils remains approximately constant. When the voltage pulses are connected, the current rises and falls at the rhythm of the voltage pulses around the center value of the support current. For example, the current responds with triangular pulses to rectangular voltage pulses. With a given voltage/time area of a voltage pulse, the amplitude of the current pulses is then determined directly by the reciprocal of the inductance. This can be seen in FIG. 6 from curves 40′, 42′ and 44′, analogously to FIG. 4.

With a central position of the body 10 between the two magnetic yokes 12 and 12′, the air gaps, and thus the two inductances of the support coils 14 and 14′, are of equal magnitude. The amplitude of the current pulses in the two support coils is thus also of equal magnitude. Because of the oppositely phased connection of the voltage pulses, the current pulses are also oppositely phased so that no current pulses flow off into phase “U”.

If shaft 10 departs from the center between the two magnetic yokes, one of the inductances becomes less and the other one of the inductances becomes greater. This can be detected from the current in coils 14 and 14′ which was caused by applying the voltage pulses at the support coils, and it can be seen in FIG. 7 from curves 40″, 42″ and 44″, analogously to FIG. 4 and FIG. 6. The current intensity is measured either directly or indirectly at phase U because, when the same current is not applied to coils 14 and 14′, the current intensity IU is different from zero. The phase terminal which is connected to the second terminals of the support coils carries both the support current and the proportion of the current pulses obtained with a noncentral position. For a position measurement, only the current pulses but not the support current must contribute to the evaluation. The signal content of the current pulses must therefore be separated from the support current. Several methods are available for this purpose in accordance with the prior art.

For example, the measurement signal of the current could be processed by means of a phase-sensitive rectifier. Another method consists, for example, in allocating to the arriving current pulses a phase angle in the three-phase system. Inverters according to the prior art have corresponding functions. Those components of the current to which a particular direction in the rotating field can be allocated and which additionally have a frequency and/or phase reference with respect to the voltage pulses can then be interpreted as measurement signal of the position.

In the arrangement according to FIG. 1, using only two coils 14 and 14′, the magnetic field can thus be produced by means of which the shaft 10 is to be supported, a force can be produced by means of which the shaft 10 is to be adjusted in the case of a deviation from equilibrium, and it is possible, by measuring the current induced by the voltage pulses, to infer the extent and the direction of the deviation of the position of the shaft 10 from the equilibrium position and a correction towards equilibrium can thus be effected.

The embodiment according to FIG. 2 differs from the embodiment according to FIG. 1 in that support coils 16 and 16′ connected in series with the support coils 14 and 14′ are arranged, the two support coils 14 and 16 being arranged symmetrically on the magnetic yoke 12 and the two support coils 14′ and 16′ being arranged symmetrically on the magnetic yoke 12′. Due to the symmetry which is greater in comparison with the embodiment according to FIG. 1, the magnetic field can be designed to be more homogeneous.

In conventional position sensors, the effective area of the position measuring device is small. In the magnetic bearing arrangements according to the invention (FIG. 1 and FIG. 2), the effective area of the position measuring device according to the invention is relatively large. This also improves the quality of the measurement result because this is obtained from the mean value over a multiplicity of single points which are located under the support coil 14 and 14′ whilst a conventional position sensor only maps a single measuring point. The magnetic bearing arrangement therefore operates in a particularly stable manner even if flexural resonances, unbalances, surface inaccuracies occur and noise is present.

In comparison with arrangements of the prior art in which a position sensor and possibly also coils for premagnetization must be provided separately, the magnetic bearing arrangement according to the three embodiments is constructed or can be constructed in a particularly compact manner.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for supporting a body with a magnetic bearing arrangement having two support coils connected in series at a connecting point, with each support coil having a first terminal coupled to a terminal of corresponding first and second voltage sources and a second terminal connected to the connecting point, said connecting point being coupled to a terminal of a third voltage source, comprising the steps of:
generating a sequence of voltage pulses at the first and second voltage sources, and
measuring an current flow between the terminal of the third voltage source caused by the voltage pulses.

2. The method of claim 1, further comprising the steps of:
supplying with the third voltage source an additional voltage at a lower frequency than a frequency of the voltage pulses at the first and second voltage sources, or a DC voltage, and
controlling the additional voltage so as to maintain a measured current flow between the terminal of the third voltage source at a predetermined current intensity value.

3. The method of claim 1, further comprising the steps of:
supplying with the third voltage source an additional voltage at a lower frequency than a frequency of the voltage pulses at the first and second voltage sources, or a DC voltage,
deriving from the measured current flow a current position of the body,
comparing the derived current position with a nominal position value and determining a comparison value, and
controlling the additional voltage with the comparison value.

4. The method of claim 1, wherein the voltage pulses have a time-averaged value of zero.

5. The method of claim 1, further comprising the step of matching the voltage pulses and the voltage at the connecting point so that the time-integrated voltage of the voltage pulses at the first and second voltage sources have equal magnitude.

6. A device for supporting a shaft of a rotor, comprising:
at least one magnetic bearing arrangement and
a controller controlling a position of the shaft in the magnetic bearing arrangement, said controller having have a device for measuring an electric current.

7. The device of claim 6, comprising two magnetic bearing arrangements having two support coils connected in series at a connecting point, with each support coil having a first terminal coupled to a terminal of corresponding first and second voltage sources and a second terminal connected to the connecting point, said connecting point being coupled to a terminal of a third voltage source, wherein the two support coils are located opposite to one another in each magnetic bearing arrangement and the support coils of a first of the two magnetic bearing arrangements is offset with respect to the support coils of the second magnetic bearing arrangement by 80° to 100° in a plane which is perpendicular to a rotor axis defined by the shaft.

8. The device of claim 7, wherein the support coils of the first magnetic bearing arrangement is offset with respect to the support coils of the second magnetic bearing arrangement by 87° to 93°.

9. The device of claim 6, wherein the controller determines an actual position from values measured by the device that measures the electric current and specifies at least one controlled variable from a comparison between the actual position and a desired position.

10. A method for supporting a body with a magnetic bearing arrangement having opposing yokes, each yoke comprising at least one support coil having a winding with two ends, with a first end of each winding connected to respective first and second voltage sources and second ends of each winding connected at a connecting point to form a series connection, said connecting point connected to a third voltage source, the method comprising the steps of:
generating with the first and second voltage sources a sequence of voltage pulses, and
measuring a current flow between the third voltage source and the connecting point caused by the voltage pulses.

11. The method of claim 10, wherein each yoke comprises two support coils having windings connected in series, with the each series connection forming the first and second winding ends.
